(19) United States
(12) Patent Application Publication
(10) Pub. No.: US 2014/0114827 A1
(43) Pub. Date: Apr. 24, 2014

(54) FEE CHECK SYSTEM AND METHOD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: CHUNG-I LEE, New Taipei (TW); DE-YI XIE, Shenzhen (CN); SHUAI-JUN TAO, Shenzhen (CN); ZHI-QIANG YI, Shenzhen (CN); JUN-CHAO YAO, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/051,517

(22) Filed: Oct. 11, 2013

(30) Foreign Application Priority Data
Oct. 23, 2012 (CN) 2012104059679

(51) Int. Cl. G06Q 50/18; G06Q 30/04

(52) U.S. Cl. CPC G06Q 50/184; G06Q 30/04
USPC 705/34

(57) ABSTRACT

A computer parses a fee list from a patent office website and saves each fee record of the fee list into a data list stored in a database. The computer calculates a first fee of each case in the data list and a second fee of each case in the patent management server. The computer notifies a person in charge of checking fee, in response to a determination that the first fee of the case does not match the second fee of the case.

### BACKGROUND

1. Technical Field

The embodiments of the present disclosure relate to management technology, and particularly to a fee check system and method.

2. Description of Related Art

When a patent application is filed in a patent office (e.g., USPTO), the applicant may need to pay a plurality of fees to the patent office. For example, the applicant should pay an examination fee. However, in some situation, due to applicants unfamiliarity with the fee processing operation, an applicant may pay twice or may not pay the fee in time. Therefore, there is room for improvement in the art.

### BRIEF DESCRIPTION OF THE DRAWINGS

FIG. 1 is a block view of one embodiment of a computer including a fee check system.

FIG. 2 is a block diagram of one embodiment of function modules of the fee check system in FIG. 1.

FIG. 3 is a flowchart of one embodiment of a fee check method.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, JAVA, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

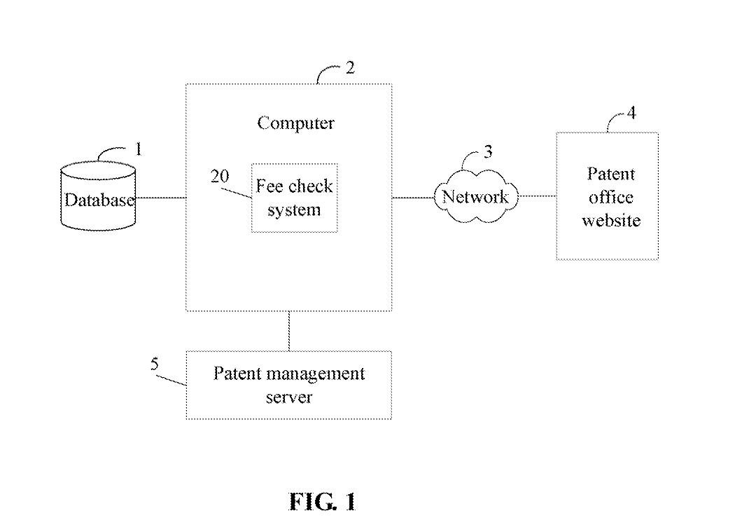

FIG. 1 is a block diagram of one embodiment of a computer 2. The computer 2 includes a fee check system 20.

The computer 2 electronically connects to a patent office website 4 via a network 3. The patent office website 4 may be, but is not limited to, owned by the State Intellectual Property Office of the People's Republic of China (e.g., http://www.sipo.gov.cn/), the Taiwan Intellectual Property Office (e.g., http://www.tipo.gov.tw/mp.asp?mp=1), the United States Patent and Trademark Office (e.g., http://www.uspto.gov/), European Patent Office (e.g., http://www.epo.org/), the Japan Patent Office website (e.g., http://www.jpo.go.jp/) or other patent office website. The network 3 may be, but is not limited to, a wide area network (e.g., the Internet) or a local area network.

The computer 2 provides a web browser for a user to access the patent office website 4 and download a fee list from the patent office website 4. The fee list includes fee records of cases passed to a patent office that owns the patent office website 4. Each case is a patent or a patent application. The fee record of each case includes an official number of the case, a day of payment of the case, an official fee code of the case, a payment amount of the case, an account number of a law firm, and a balance of the account number. In one embodiment, the official number of the case is provided by the patent office. For example, if the case is a patent application filed to USPTO, the official number of the case is a patent application number (e.g., 12/820,033) provided by the USPTO. If the case is a patent issued by USPTO, the official number of the case is a patent number (e.g., U.S. Pat. No. 8,380,983 B2) provided by USPTO. The official fee code of the case represents how much money has been paid by the applicant. For example, according to USPTO, the official fee code “1311/2311/3311” indicates a utility examination fee 720$. Additionally, the cases are agented by the law firm, and the user may be an accountant of a law firm who is in charge of managing an account number for accessing to the patent office website 4.

The computer 2 electronically connects to a database 1 using open database connectivity (ODBC) or JAVA database connectivity (JDBC), for example. The database 1 may store the fee list downloaded from the patent office website 4.

The computer 2 also electronically connects to a patent management server 5. The patent management server 5 stores each case and information of each case and manages each case. The information of each case may originally include a predetermined number of the case, an invention name of the case, a technical field of the case, a patent agent in charge of the case, names of one or more inventors, and a contact line (e.g., telephone number: 123456). The predetermined number of the case is predetermined by a law firm and is used in the law firm for managing the case, for example, the predetermined number of the case may be “2012A-57388/US46230.” The information of each case may be later updated after the case is filed to the patent office. For example, the information of each case may include the official number, the date of payment, a predetermined fee code, a payment amount and other information after the case is filed to the patent office. The predetermined fee code is predetermined by the law firm and corresponds to the official fee code. For example, the predetermined fee code “A” corresponds to the utility examination fee.

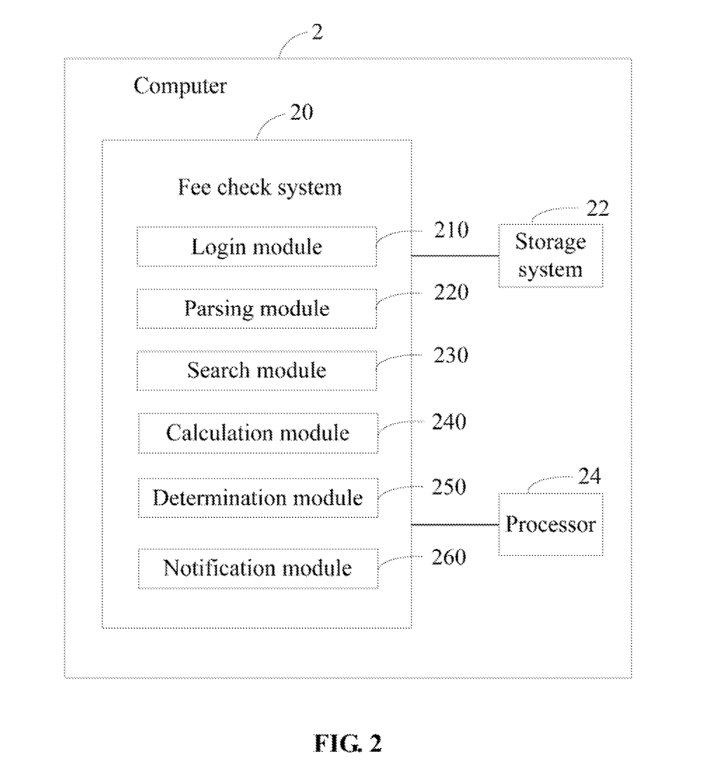

FIG. 2 is a block diagram of one embodiment of function modules of the fee check system 20. In one embodiment, the computer 2 further includes a storage system 22, and at least one processor 24. The fee check system 20 includes a login module 210, a parsing module 220, a search module 230, a calculation module 240, a determination module 250 and a notification module 260. The modules 210-260 may include computerized code in the form of one or more programs that are stored in the storage system 22. The computerized code includes instructions that are executed by the at least one processor 24 to provide functions for the modules 210-260. The storage system 22 may be a memory, such as an EPROM memory chip, hard disk drive (HDD), or flash memory stick.

The login module 210 logs into the patent office website 4 and downloads a fee list from the patent office website 4 into the database 1. In one embodiment, an accountant of the law firm inputs a password and a name in the web browser installed in the computer 2 and logs into the patent office website 4.

The parsing module 220 parses the fee list and saves each fee record of the fee list into a data list. In one embodiment, the data list stores each fee record of the fee list from the patent office website 4 and also stores the predetermined number and the predetermined fee code of each case from the patent management server 5. In other words, the data list is integrated with the fee list and the information of each case.

The search module 230 searches for the predetermined number of each case and the predetermined fee code of each case from the patent management server 5 according to the official number of the case of the fee record in the data list, and saves the predetermined fee code of each case into the data list. In one embodiment, the search module 230 searches for the official number of each case in the data list, and searches for the predetermined fee code of the case from the patent management server 5 according to the searched official number of the case. The predetermined number of each case is associated with the fee record in the data list when the predetermined number of each case is saved into the data list. The predetermined fee code of the case is associated with the fee record in the data list when the predetermined fee code of each case is saved into the data list.

The calculation module 240 calculates a first fee of each case in the data list. In one embodiment, the calculation module 240 calculates the first fee of each case in the data list according to the predetermined number of the case, the predetermined fee code of the case, and the date of payment. For example, the calculation module 240 searches for the payment amount of each case according to the predetermined number of the case, the predetermined fee code of the case, and the date of payment. The first fee of the case is equal to a sum of all searched payment amount of the case in the data list.

The calculation module 240 calculates a second fee of each case in the patent management server 5. In one embodiment, the calculation module 240 calculates the second fee of each case in the patent management server 5 according to the predetermined number of the case, the predetermined fee code of the case, and the date of payment. For example, the calculation module 240 searches for the payment amount of each case according to the predetermined number of the case, the predetermined fee code of the case, and the date of payment. The second fee of the case is equal to the sum of all searched payment amount of the case in the patent management server 5.

The determination module 240 determines if the first fee of the case matches the second fee of the case. In one embodiment, if the first fee equals to the second fee, the first fee of the case is determined as matching the second fee of the case.

The notification module 260 notifies a person in charge of checking fees, in response to a determination that the first fee of the case does not match the second fee of the case. The person may be, but is not limited to, an accountant. The notification module 260 may generates an alert message when the first fee of the case does not match the second fee of the case. The alert message includes the official number of the case, the predetermined number of the case, and the date of payment.

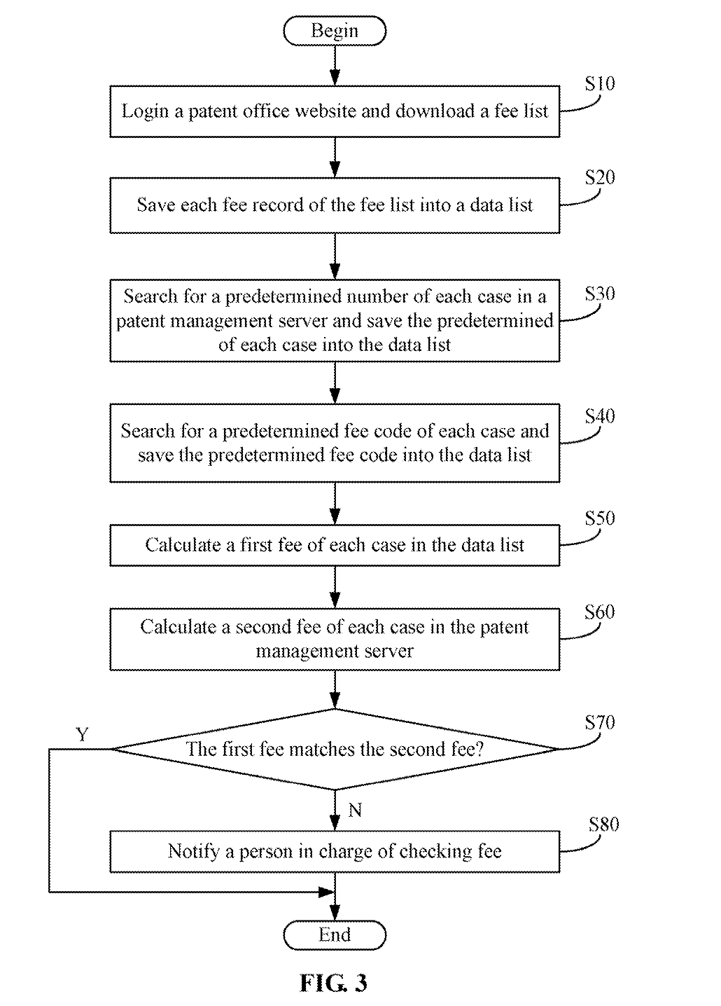

FIG. 3 is a flowchart of one embodiment of a fee check method. Depending on the embodiment, additional steps may be added, others deleted, and the ordering of the steps may be changed.

In step S10, the login module 210 logs into the patent office website 4 and downloads a fee list from the patent office website 4 into the database 1. In one embodiment, the login module 210 accesses the patent office website 4 when the accountant of the law firm inputs the password and the name in the web browser installed in the computer 2.

In step S20, the parsing module 220 parses the fee list and saves each fee record of the fee list into a data list. As mentioned above, the data list is integrated with the fee list and the information of each case.

In step S30, the search module 230 searches for the predetermined number of each case from the patent management server 5 according to the data list, and saves the predetermined number of each case into the data list. For example, if the official number of the case is “12/820,033.” In one embodiment, the search module 230 searches for “12/820,033” in the data list, and uses “12/820,033” as a keyword to search for the predetermined number of the case “2012A-57388/US46230.” The predetermined number of the case is associated with the fee record in the data list when the predetermined number of the case “A” is saved into the data list.

In step S40, the search module 230 searches for the predetermined fee code of each case from the patent management server 5 according to the data list, and saves the predetermined fee code of each case into the data list. In one embodiment, the search module 230 searches for “12/820,033” in the data list, and uses “12/820,033” as the keyword to search for the predetermined fee code of the case “A” in the patent management server 5. The predetermined fee code of the case “A” is associated with the fee record in the data list when the predetermined fee code of the case “A” is saved into the data list.

In step S50, the calculation module 240 calculates a first fee of each case in the data list. In one embodiment, the calculation module 240 calculates the first fee of each case in the data list according to the predetermined number of the case, the predetermined fee code of the case, and the date of payment. For example, the calculation module 240 searches for the payment amount of each case according to the predetermined number of the case, the predetermined fee code of the case, and the date of payment in the data list. The first fee of the case is equal to a sum of all searched payment amount of the case in the data list.

In step S60, the calculation module 240 calculates a second fee of each case in the patent management server 5. In one embodiment, the calculation module 240 calculates the second fee of each case in the patent management server 5 according to the predetermined number of the case, the predetermined fee code of the case, and the date of payment. For example, the calculation module 240 searches for the payment amount of each case according to the predetermined number of the case, the predetermined fee code of the case, and the date of payment. The second fee of the case is equal to the sum of all searched payment amount of the case in the patent management server 5.

In step S70, the determination module 250 determines if the first fee of the case matches the second fee of the case. In one embodiment, if the first fee of the case is 1640$, and the second fee of the case is also 1640$, the first fee of the case matches the second fee of the case, the procedure ends. Otherwise, if the first fee of the case is 1640$, and the second fee of the case is 1440$, the first fee of the case does not match the second fee of the case, the procedure goes to step S80.

In step S80, the notification module 260 notifies a person in charge of checking fee, in response to a determination that the first fee of the case does not match the second fee of the case. The person may be, but is not limited to, an accountant. In one embodiment, the notification module 260 may sends an alert message to the person using an E-mail or a short message service.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer, comprising:
at least one processor; and
a storage system that stores one or more programs, when executed by the at least one processor, cause the at least one processor to perform a fee check method, the method comprising:
downloading a fee list from a patent office website, and storing the fee list into a database connected to the computer, wherein the fee list comprises a fee record of each case, and the fee record of each case comprises an official number of the case and a day of payment of the case;
parsing the fee list and saving the fee record of each case into a data list stored in the database;
searching for a predetermined number of each case from a patent management server connected to the computer according to the official number of the case of the fee record in the data list, and saving the predetermined number of each case into the data list;
searching for a predetermined fee code of each case from the patent management server according to the official number of the case of the fee record in the data list, and saving the predetermined fee code of each case into the data list;
calculating a first fee of each case in the data list according to the date of payment of the case, the predetermined number of the case and the predetermined fee code of the case;
calculating a second fee of each case in the patent management server according to the date of payment of the case, the predetermined number of the case and a predetermined fee code of the case; and
notifying a person in charge of checking fee, in response to a determination that the first fee of the case does not match the second fee of the case.

2. The computer of claim 1, wherein the fee record of each case comprises an official fee code of the case, an account number of a law firm, and a balance of the account number.

3. The computer of claim 2, wherein the official number of the case and the official fee code of the case are provided by a patent office.

4. The computer of claim 2, wherein the predetermined number of the case and the predetermined fee code of the case are predetermined by a law firm, and the predetermined fee code corresponds to the official fee code.

5. The computer of claim 1, wherein the first fee of the case is equal to a sum of all searched payment amount of the case in the data list, and the payment amount of the case is searched according to the predetermined number of the case, the predetermined fee code of the case, and the date of payment in the data list.

6. The computer of claim 1, wherein the second fee of the case is equal to a sum of all searched payment amount of the case in the patent management server, and the payment amount of the case is searched according to the predetermined number of the case, the predetermined fee code of the case, and the date of payment in the patent management server.

7. A fee check method implemented by a computer, the method comprising:
downloading a fee list from a patent office website, and storing the fee list into a database connected to the computer, wherein the fee list comprises a fee record of each case, and the fee record of each case comprises an official number of the case and a day of payment of the case;
parsing the fee list and saving the fee record of each case into a data list stored in the database;
searching for a predetermined number of each case from a patent management server connected to the computer according to the official number of the case of the fee record in the data list, and saving the predetermined number of each case into the data list;
searching for a predetermined fee code of each case from the patent management server according to the official number of the case of the fee record in the data list, and saving the predetermined fee code of each case into the data list;
calculating a first fee of each case in the data list according to the date of payment of the case, the predetermined number of the case and the predetermined fee code of the case;
calculating a second fee of each case in the patent management server according to the date of payment of the case, the predetermined number of the case and a predetermined fee code of the case; and
notifying a person in charge of checking fee, in response to a determination that the first fee of the case does not match the second fee of the case.

8. The method of claim 7, wherein the fee record of each case comprises an official fee code of the case, an account number of a law firm, and a balance of the account number.

9. The method of claim 8, wherein the official number of the case and the official fee code of the case are provided by a patent office.

10. The method of claim 8, wherein the predetermined number of the case and the predetermined fee code of the case are predetermined by a law firm, and the predetermined fee code corresponds to the official fee code.

11. The method of claim 7, wherein the first fee of the case is equal to a sum of all searched payment amount of the case in the data list, and the payment amount of the case is searched according to the predetermined number of the case, the predetermined fee code of the case, and the date of payment in the data list.

12. The method of claim 7, wherein the second fee of the case is equal to a sum of all searched payment amount of the case in the patent management server, and the payment amount of the case is searched according to the predetermined number of the case, the predetermined fee code of the case, and the date of payment in the patent management server.

13. A non-transitory computer-readable medium having stored thereon instructions that, when executed by a computer, causing the computer to perform a fee check method, the method comprising:
downloading a fee list from a patent office website, and storing the fee list into a database connected to the computer, wherein the fee list comprises a fee record of each case, and the fee record of each case comprises an official number of the case and a day of payment of the case;
parsing the fee list and saving the fee record of each case into a data list stored in the database;
searching for a predetermined number of each case from a patent management server connected to the computer according to the official number of the case of the fee record in the data list, and saving the predetermined number of each case into the data list;
searching for a predetermined fee code of each case from the patent management server according to the official number of the case of the fee record in the data list, and saving the predetermined fee code of each case into the data list;
calculating a first fee of each case in the data list according to the date of payment of the case, the predetermined number of the case and the predetermined fee code of the case;
calculating a second fee of each case in the patent management server according to the date of payment of the case, the predetermined number of the case and a predetermined fee code of the case; and
notifying a person in charge of checking fee, in response to a determination that the first fee of the case does not match the second fee of the case.

14. The non-transitory computer-readable medium of claim 13, wherein a day of payment of the case, an official fee code of the case, an account number of a law firm, and a balance of the account number.

15. The non-transitory computer-readable medium of claim 14, wherein the official number of the case and the official fee code of the case are provided by a patent office.

16. The non-transitory computer-readable medium of claim 14, wherein the predetermined number of the case and the predetermined fee code of the case are predetermined by a law firm, and the predetermined fee code corresponds to the official fee code.

17. The non-transitory computer-readable medium of claim 13, wherein the first fee of the case is equal to a sum of all searched payment amount of the case in the data list, and the payment amount of the case is searched according to the predetermined number of the case, the predetermined fee code of the case, and the date of payment in the data list.

18. The non-transitory computer-readable medium of claim 13, wherein the second fee of the case is equal to a sum of all searched payment amount of the case in the patent management server, and the payment amount of the case is searched according to the predetermined number of the case, the predetermined fee code of the case, and the date of payment in the patent management server.
